(19) United States
(12) Patent Application Publication
(10) Pub. No.: US 2008/0309113 A1
(43) Pub. Date: Dec. 18, 2008

(54) Motor Vehicle Dashboard Cross-Member, an Assembly Including Such a Cross-Member, and Method of Fabricating Such a Cross-Member

(75) Inventor: Laurent Baudart, Fresnoy En Thelle (FR)

Correspondence Address: YOUNG & THOMPSON, 209 Madison Street, Suite 500, ALEXANDRIA, VA, 22314, US

(73) Assignee: FAURECIA INTERIEUR INDUSTRIE, Nanterre (FR)

(21) Appl. No.: 11/883,328

(22) PCT Filed: Jan. 5, 2006
(86) PCT No.: PCT/FR06/00020

§ 371 Date: Jul. 30, 2007

(30) Foreign Application Priority Data
Feb. 3, 2005 (FR) 0501108
Jul. 22, 2005 (FR) 0507844

(51) Int. Cl. B62D 25/14

(52) U.S. Cl. 296/70; 29/897.2; 29/428; 29/557

(57) ABSTRACT

A crossmember includes a long beam (4) that forms at least one section of the crossmember. The beam (4) is formed by an open section (19) which is obtained by bending a metal strip longitudinally in order to produce a section with a determined cross-section.

The present invention relates to a motor vehicle dashboard crossmember of the type comprising an elongate beam forming at least one segment of the crossmember.

Motor vehicle dashboard crossmembers serve to stiffen the body of the motor vehicle and to support pieces of motor vehicle equipment, in particular a dashboard, a steering column, and air ducts of an air conditioning system.

Car manufacturers have ever stricter requirements in terms of the vibration transmitted by dashboard crossmembers and the impact resistance of said crossmembers.

One solution suitable for limiting vibration in a crossmember consists in increasing the moment of inertia of the crossmember, e.g. by increasing the thickness of the crossmember, but that nevertheless leads to an increase in weight.

A solution that enables impact resistance of a crossmember to be improved consists in modifying the section of the crossmember. Nevertheless, the resulting crossmember is generally complex in shape, making it more complicated to fabricate.

An object of the present invention is to propose a dashboard crossmember that is capable of being fabricated easily.

To this end, the invention provides a dashboard crossmember of the above-specified type, characterized in that the beam is formed from an open section member formed by longitudinally bending a metal strip in order to obtain a member of determined section.

In other embodiments, the dashboard crossmember includes one or more of the following characteristics, taken in isolation or in any technically feasible combination:
the section member presents a section defining at least two juxtaposed channels extending parallel to each other along the length of the section member;
the channels present sections that are closed;
at least one channel presents a section that is open, and at least one channel presents a section that is closed;
the open channel is defined by a channel-section portion of the section member that has a U-shape section, and the closed channel is defined by a portion of the section member that has an O-shaped section;
the open channel and the closed channel are defined by at least one wall in common;
the section member presents varying thickness in a cross-section plane; and
over another segment of the crossmember, the crossmember includes an intermediate beam fastened to said beam.

The invention also provides an assembly comprising a crossmember as defined above together with at least one air duct of a motor vehicle air conditioning system, the or each air duct extending in the open channel that forms a cavity for receiving the or each air duct.

The invention also provides a method of fabricating a motor vehicle dashboard crossmember beam in which a section member is formed from a metal strip or blank that is folded along a plurality of longitudinal lines.

In other implementations, the method includes one or more of the following steps performed in isolation or in any technically feasible combination:
closing the section member at least in part, so as to obtain a section defining at least one closed channel by using continuous or discontinuous connection means, e.g. of the stapling, folding/crimping, pinching, or welding types, either during the process of shaping the section member, or subsequently;
forming a section member from a metal strip that is moved longitudinally continuously through a roller bending machine so as to bend the metal strip progressively along longitudinal lines so as to obtain a section member of determined section, and a segment is taken from the section member in order to form the beam;
closing the section member by means of a longitudinal weld formed continuously along the section member traveling longitudinally at the outlet from the bending machine, prior to cutting off the beam;
forming the section member from a blank cut to the format of the beam, which blank is allowed to pass through a succession of folding presses so as to fold the blank progressively along fold lines in order to obtain a section member of determined section, constituting the beam;
forming openings in the strip, prior to bending the strip, the openings being distributed along at least one longitudinal line so as to obtain a beam provided with openings distributed along its length; and
forming the strip or the blank by at least two strips of different thicknesses assembled together along their longitudinal edges, so that the section member presents varying thickness in a section plane.

The invention and its advantages can be better understood on reading the following description, given purely by way of example, and made with reference to the accompanying drawings, in which:

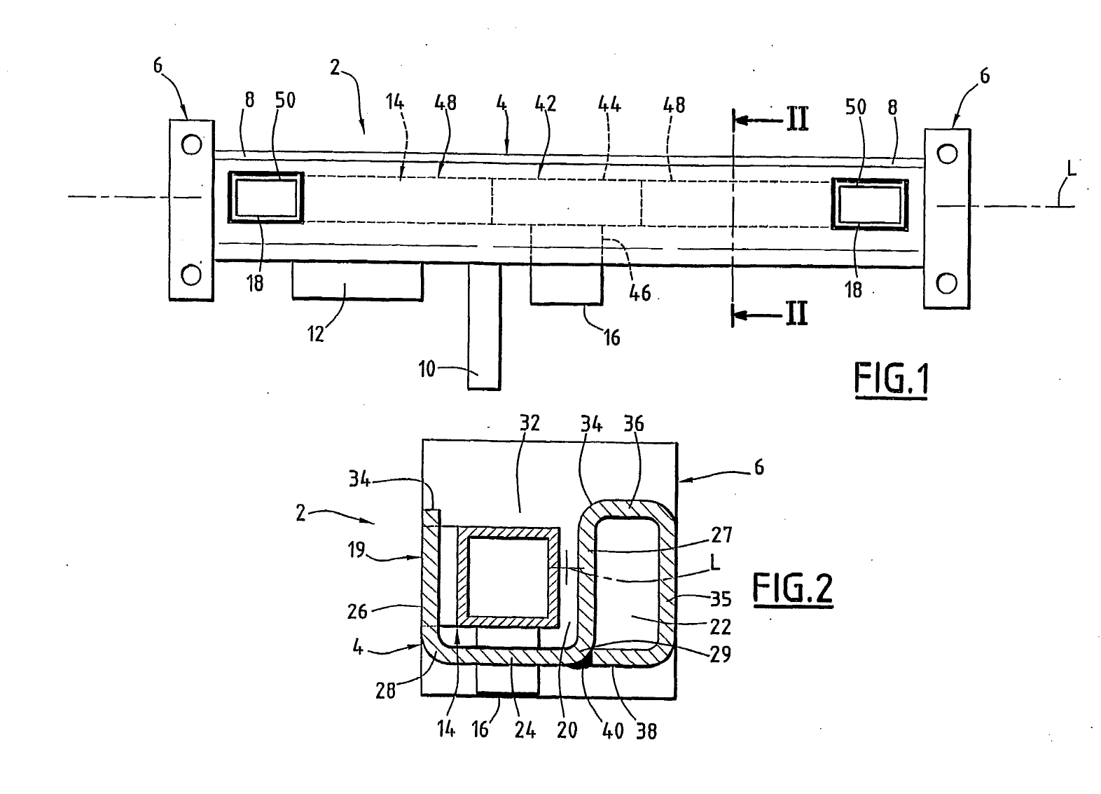

FIG. 1 is a rear view of a dashboard crossmember in accordance with the invention, receiving air ducts of an air conditioning system;

FIG. 2 is a section view on II-II of the FIG. 1 crossmember;

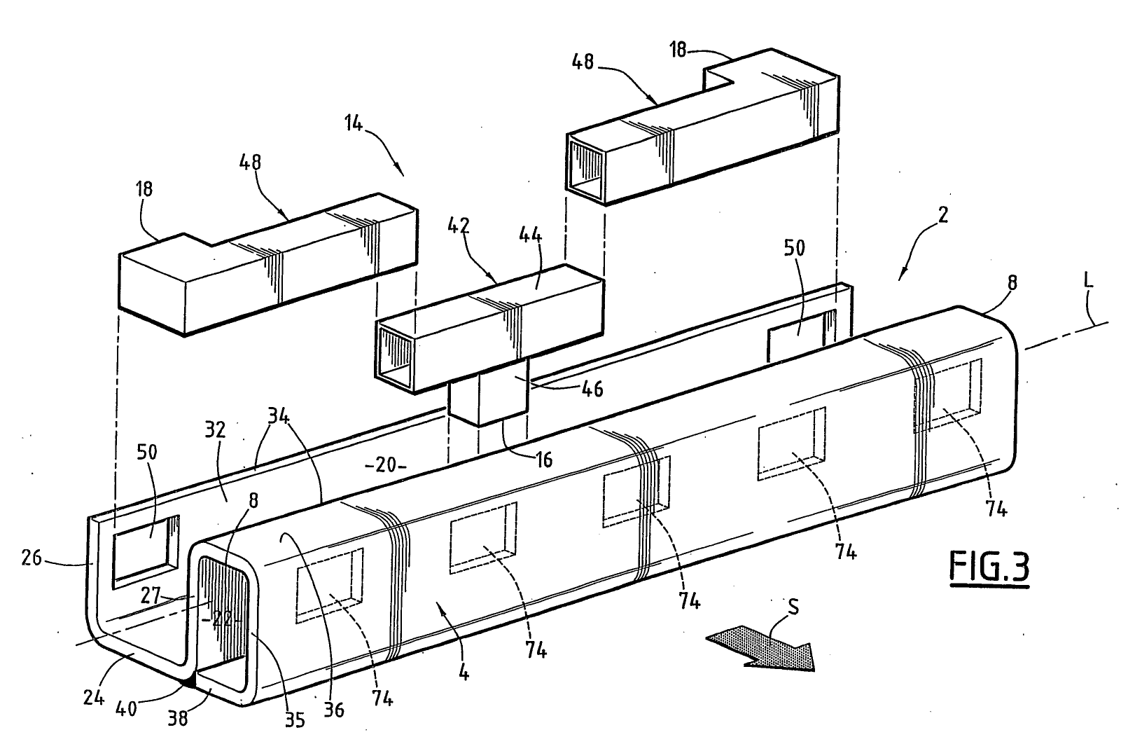

FIG. 3 is an exploded perspective view of a beam of the FIG. 1 crossmember and of the FIG. 1 air ducts;

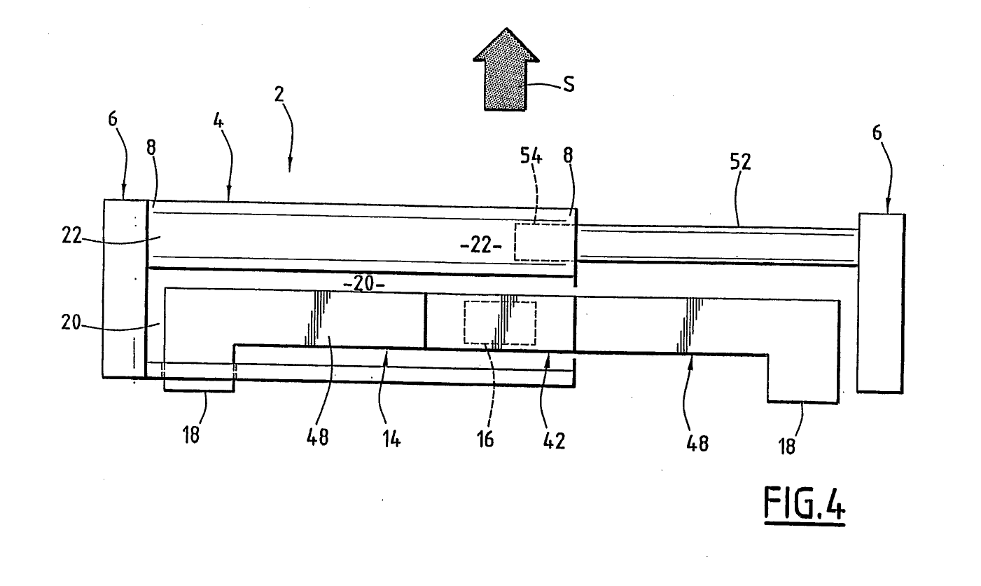

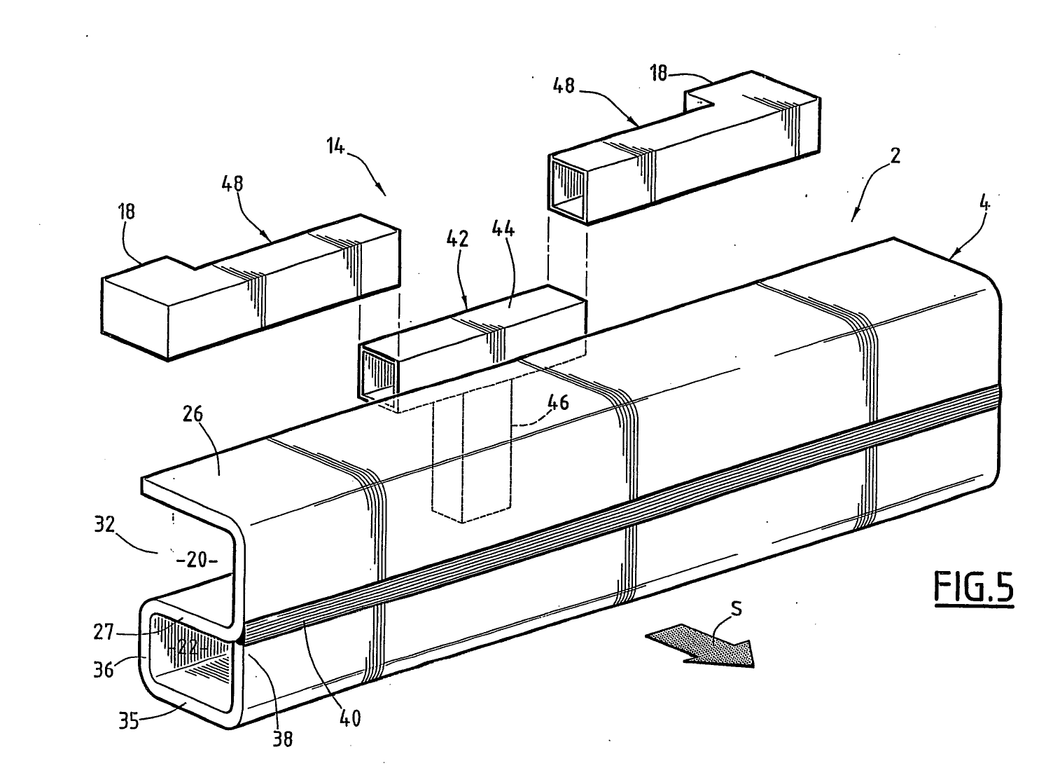

FIG. 4 is a plan view of a crossmember constituting a variant of the FIG. 1 crossmember;

FIG. 5 is a view analogous to FIG. 3, showing a beam of a crossmember constituting a variant of the FIG. 3 crossmember;

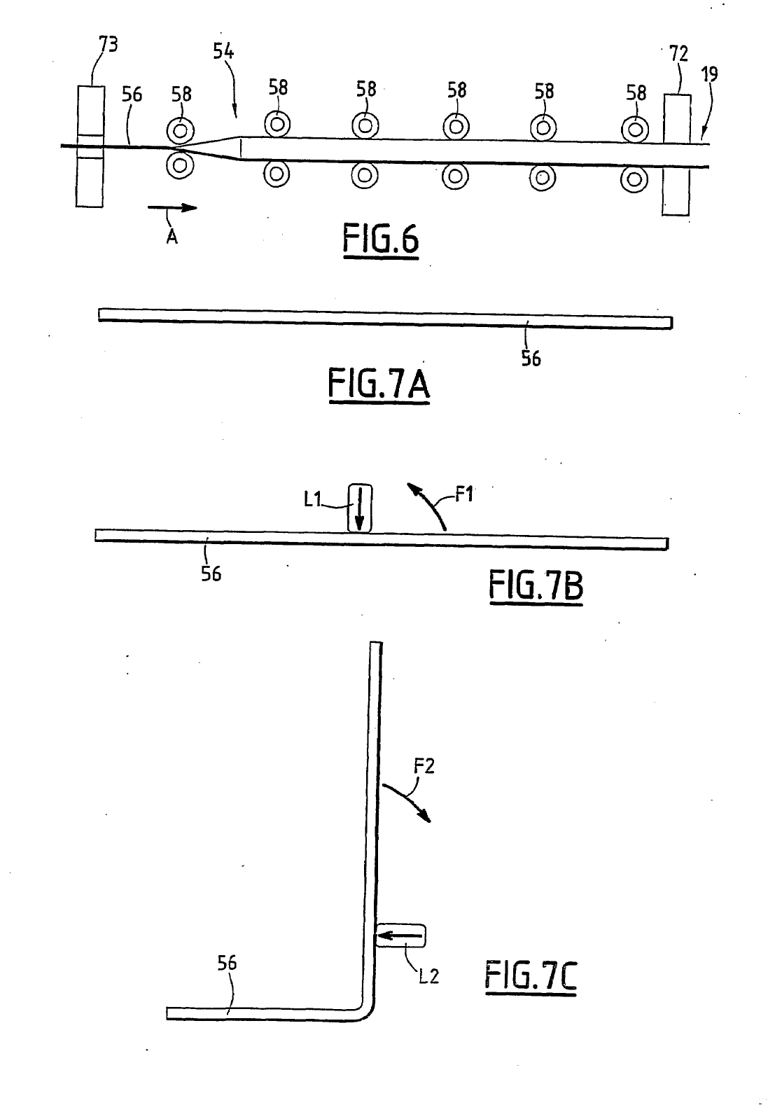

FIG. 6 is a diagrammatic view of a profiling installation enabling a beam for a crossmember in accordance with the invention to be formed from a metal strip;

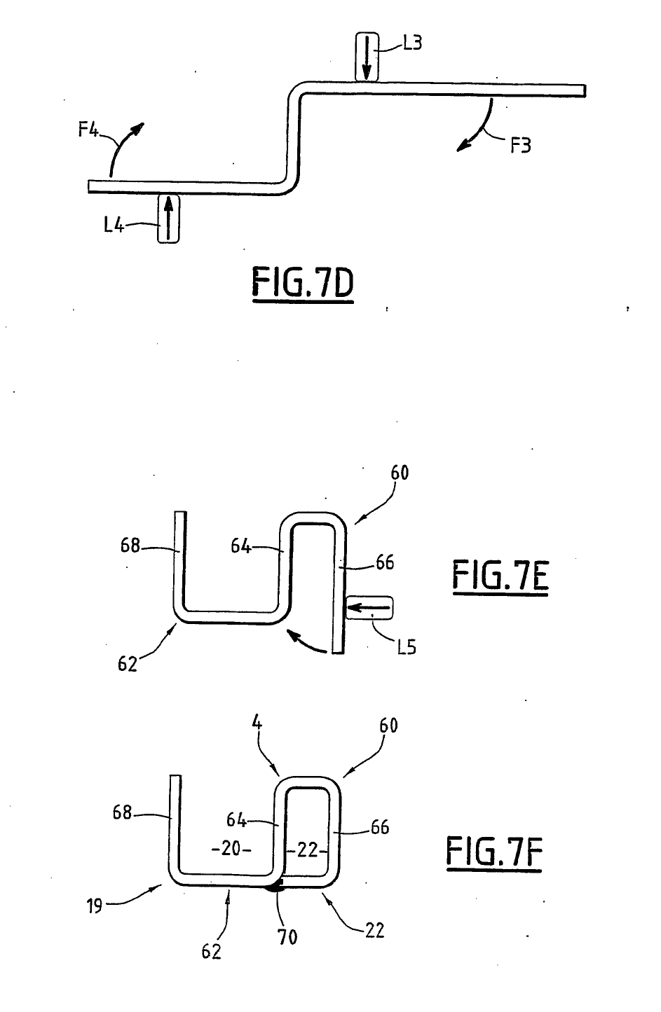

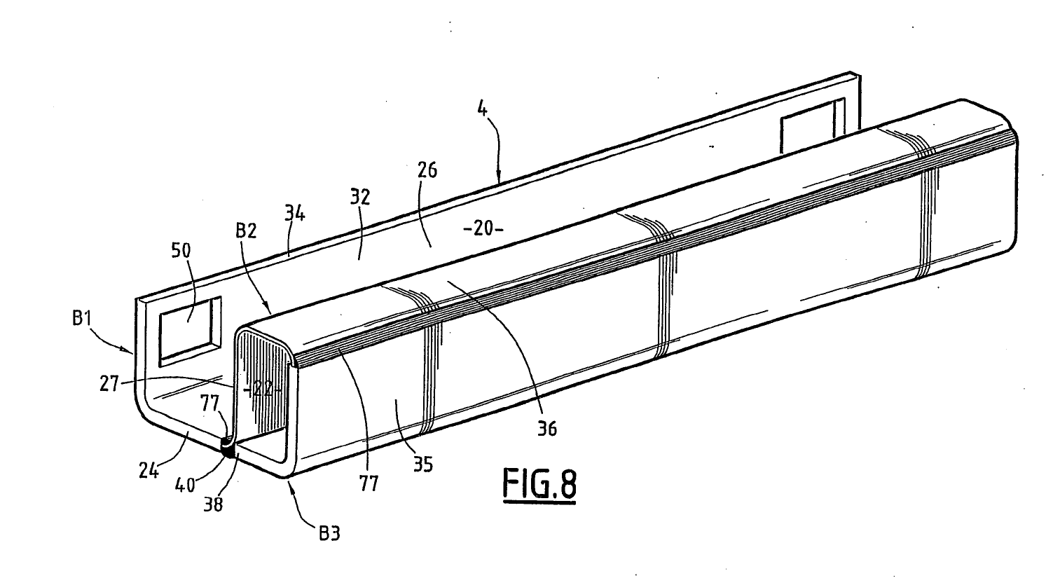

FIGS. 7A to 7F are section views of a metal strip during successive steps of folding the metal strip in the FIG. 6 installation in order to obtain the beam of FIGS. 1 to 3;

FIG. 8 is a view analogous to FIG. 3 showing a beam of a crossmember constituting a variant of the FIG. 3 crossmember;

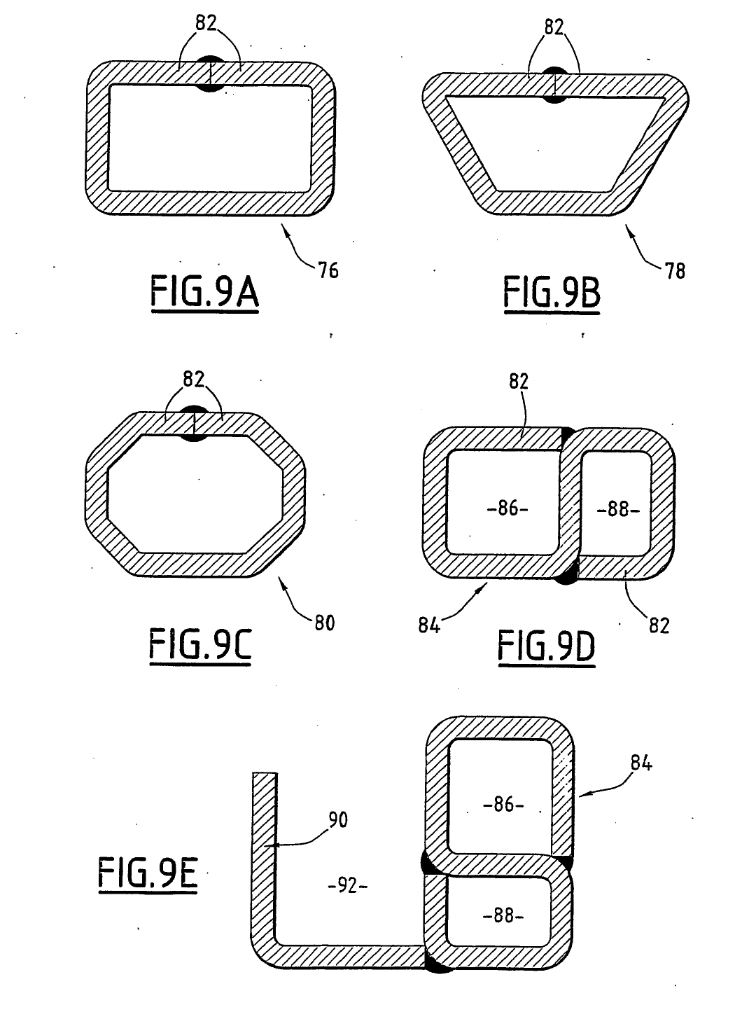

FIGS. 9A to 9E show sections that can be obtained using an installation of the kind shown in FIG. 6;

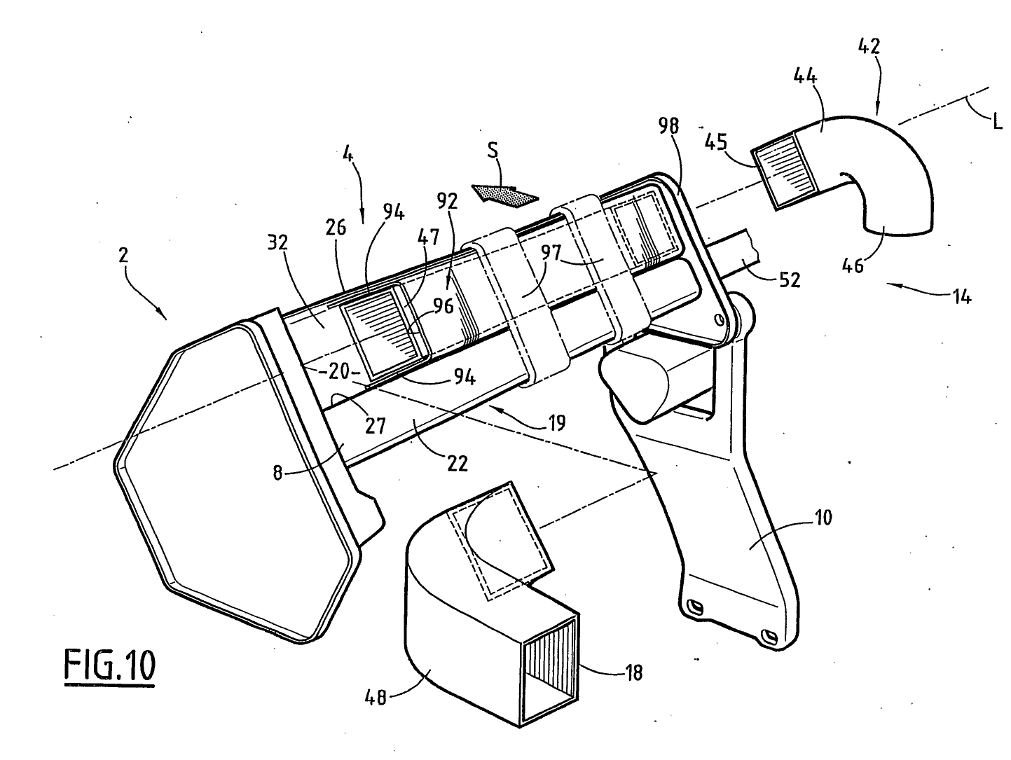

FIG. 10 is a fragmentary perspective view of the left-hand side of a variant of the FIG. 4 crossmember;

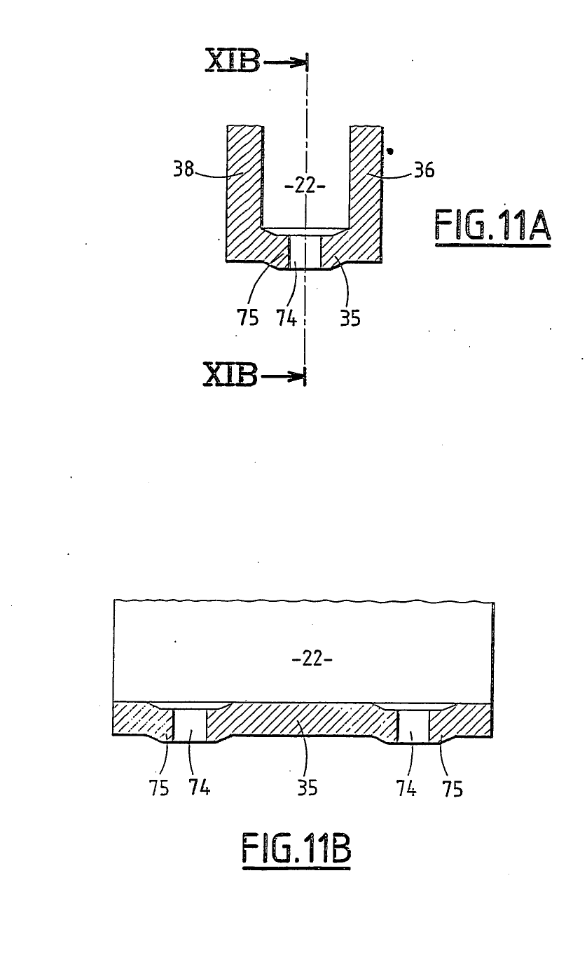

FIG. 11A is a fragmentary section view in a plane perpendicular to the direction L showing a front side of the closed channel 22 of the FIG. 3 crossmember, with a variant embodiment of the holes 74;

FIG. 11 B is a section view on arrows XIB of FIG. 11A;

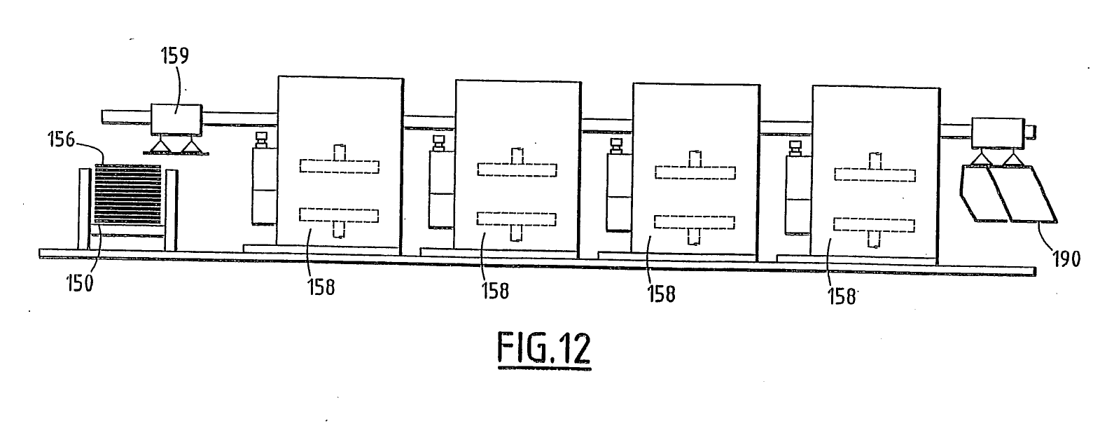

FIG. 12 is a diagrammatic view of an installation for fabricating a beam by transfer between a plurality of folding machines; and

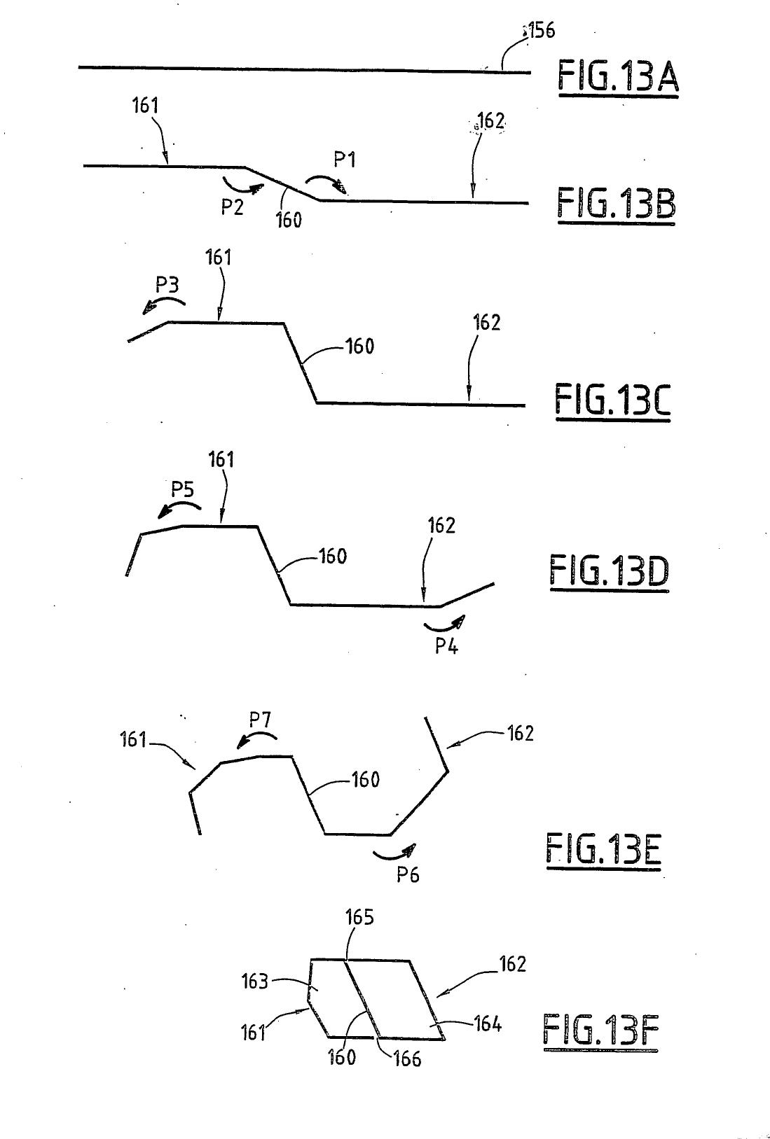

FIGS. 13A to 13F are diagrams of the method of fabricating a beam by a succession of folding operations.

In the description below, the directions used are the usual directions for motor vehicles.

Thus, terms such as “high”, “low”, “front”, “rear”, “right”, “left”, “horizontal”, “vertical”, and “side”, should be understood relative to the position of the driver and the direction in which the vehicle advances when going forwards, as represented by arrow S in FIGS. 3, 4, and 5.

As shown in FIG. 1, a dashboard crossmember 2 comprises:
an elongate beam 4 extending along a line L. The line L may be rectilinear, for example;
fastener devices 6 fastened to the ends 8 of the beam 4;
a force strut 10 fastened to the beam 4 at a distance from the ends 8; and
a steering column support 12 fastened to the beam 4 between the force strut 10 and the left-hand end of the beam 4.

The fastener devices 6, the force strut 10, and the support 12 are conventional and are not described in detail below.

The fastener devices 6 are for fastening to uprights A of a motor vehicle, such that the beam 4 extends between the uprights A.

The force strut 10 is designed to have its bottom end fastened to a central tunnel (not shown) of the motor vehicle.

The support 12 is for supporting a steering column (not shown) carrying a steering wheel at its rear and top end, and connected at its front and bottom end to a mechanism for steering the wheels of the motor vehicle.

An air circuit 14 is fastened to the beam 4. The air circuit 14 has an air intake 16 for connection to an air conditioner unit (not shown) that includes air heater and/or cooler means, and means for blowing air along the circuit 14 via the intake 16.

The air circuit 14 has outlets 18 for connection to air vents (not shown) distributed around the cabin of the motor vehicle.

As shown in FIG. 2, the beam 4 comprises a hollow section member 19 extending along the line L, and presenting a section that is constant along the line L. The section member 19 comprises two juxtaposed channels 20 and 22 extending parallel to each other along the line L, i.e. perpendicularly to the plane of FIG. 2.

More precisely, the beam 4 has an open first channel 20 and a closed second channel 22.

The first channel 20 is defined by a portion of the section member 19 that is substantially of U-shaped section, being upwardly open. The first channel 20 is defined by a web 24, a rear flange 26, and a front flange 27. The flanges 26 and 27 are parallel and extend vertically upwards from the web 24. The flanges 26 and 27 are connected to the web 24 via rounded connection portions, respectively a rear connection portion 28 and a front connection portion 29. The first channel 20 presents a top opening 32 that extends along the length of the section member 19, and that is defined by the top ends 34 of the flanges 26, 27.

The second channel 22 is defined by a portion of the section member 19 presenting a closed section substantially in the form of a rectangular O-shape. The second channel 22 is defined by the front flange 27, and by a C-shaped front branch 35, situated in front of the front flange 27, and having a top segment 36 and a bottom segment 38. The end edge of the segment 38 is secured by a bead of welding 40 to the front connection portion 39.

The channels 20 and 22 are defined by a common wall, i.e. the flange 27, which thus forms a separation between the channels 20 and 22.

The section member 19 constitutes a single piece and thus presents a section that is substantially 6-shaped.

The air circuit 14 is received inside the open channel 20.

As can be seen more clearly in FIG. 3, the air circuit 14 has a T-shaped tubular coupling 42 comprising an arm 44 and a shank 46. A bottom opening of the shank 46 defines the air intake 16.

The circuit 14 has two side ducts 48. Each side duct 48 is connected to one end of the arm 44 and extends sideways outwards therefrom. At its opposite end, each duct 48 is bent rearwards and presents an opening defining an outlet 18.

After the coupling 42 and the ducts 48 have been assembled together, the circuit 14 is easily inserted into the open channel 20 via the opening 32.

The tubular coupling 42 and the ducts 48 are force-fitted in the open channel 20 or they are fastened in said channel by means such as adhesive or staples.

The rear flange 26 presents openings 50 situated close to the ends 8 of the beam 4, in register with the openings of the outlets 18.

At a distance from each of the ends 8, the web 24 has an opening (not shown) through which the shank 46 extends in order to be connected to the air conditioning system (not shown).

After assembly, a configuration is achieved as shown in FIGS. 1 and 2.

The beam 4 presents a section defining an open channel 20 for receiving the air circuit 14 and enables the air circuit 14 to be received in a manner that is compact, with assembly that is easy.

The section defining a closed channel 22 gives the beam 4 a high degree of stiffness and a high level of impact resistance.

As shown in FIG. 4, in a variant, the beam 4 constitutes only a segment of limited length of the crossmember 2. The left-hand end 8 of the beam 4 is fastened to a fastener device 6, and the right-hand end of the beam 4 is situated at a distance from the right-hand fastener device 6.

An intermediate beam 52 extends between the right-hand end 8 of the beam 4 and the fastener device 6. The intermediate beam 52 presents an end 54, drawn in dashed lines, that is inserted over a limited length inside the closed channel 22. The beam 52 is fastened to the beam 4 by being inserted by force or by using any other suitable means such as adhesive, screw-fastening, or welding.

As shown in FIG. 4, only one left-hand duct 48 and the coupling 42 are received inside the open channel 20, while the right-hand duct 48 is situated outside it. In a variant, the beam 4 is even shorter, such that only the left-hand duct 48 is received in the open channel 20.

In a variant shown in FIG. 5, the opening 32 of the open channel 20 faces horizontally rearwards. The circuit 14 is disposed in such a manner that the outlets 18 are directed horizontally rearwards through the opening 32. The flange 27 and the C-shaped portion 35 of the section member 19 define a closed channel 22 and are provided with orifices (not shown) in alignment enabling the shank 46 of the T-shaped coupling 42 to pass through in order to be coupled to the air conditioning system. In order to facilitate assembly, the shank 46 and the arms 44 of the T-shaped coupling 42 are releasably mounted relative to one another.

In a variant, the beam 4 has at least two open channels and/or at least two closed channels.

Alternatively, or optionally, the open channel 20 is used for receiving other pieces of motor vehicle equipment, such as electric cabling.

The crossmember shown in FIG. 10 is a variant of that shown in FIG. 4. Only the differences between these crossmembers are described below.

The beam 4 of the crossmember of FIG. 10 includes a longitudinal reinforcing part 92 of channel section in a plane perpendicular to the longitudinal direction and engaged in the channel 20. This part is placed in the zone of the steering column support 12 so as to stiffen this zone. This part presents two parallel and opposite flanges 94 and a web 96 interconnecting the two flanges 94. It is disposed in the channel 20 so that the flanges 94 are pressed against the front and rear flanges 26 and 27 defining the channel 20 and so that the web 96 partially closes the opening 32 of the channel 20.

The reinforcing part 92 is shorter than the channel 20 in the longitudinal direction L, such that the opening 32 of the channel 20 is unemcumbered at the left-hand end 8.

The reinforcing part 92 is welded to the section member 19 or fastened thereto using straps 97 that are screw-fastened or clipped onto the section member 19, these straps 97 holding the part 92 pressed against the web of the open channel 20 (see FIG. 10).

Because of the presence of the reinforcing part 92, it is no longer possible to insert the elements of the air circuit 14 in the channel 20 through the open face 32.

To mitigate this difficulty, the air circuit 14 includes a link duct 47 connecting the left-hand duct 48 to one end 45 of the arm 44 of the tubular coupling 42. Furthermore, the tubular coupling 42 is disposed in such a manner that only the end 45 of the arm 44 is engaged in the open channel 20, the shank 46 remaining outside the open channel 20 and extending from the end of the beam 4 rearwards and downwards, going around the intermediate beam 52.

The elements of the air circuit 14 are mounted in the open channel 20 as follows. The connection duct 47 is initially slid longitudinally into the channel 20 from the right-hand end of the channel, until the duct is positioned longitudinally under the reinforcing part 92. The side duct 48 is inserted via the left-hand portion of the open face 32, is left free, and is connected to the link duct 47 by any appropriate means. Thereafter, the tubular coupling 42 is put into place, the end 45 of the arm 44 being inserted into the open channel 20 and connected to the intermediate duct 47. Finally, the right-hand side duct 48 is connected to the arm 44.

In another original aspect of the FIG. 10 variant embodiment, the beam 4 is inclined a little relative to the vertical, so that the open channel 20 is disposed higher and nearer the front of the vehicle, with the closed channel 22 being disposed lower and nearer the rear of the vehicle.

The open face 32 faces upwards and rearwards. It can be seen in FIG. 10 that with this orientation of the beam 4, the angled portion of the duct 48 exits the channel 20 via the open face 32 and rests on an outside face of the closed channel 22, the channel holding the angled portion in position.

According to yet another aspect of the FIG. 10 variant embodiment, the crossmember includes a fastener plate 98 extending in a plane perpendicular to the direction L, with the force strut 10 being rigidly fastened thereto. The plate 98 is placed against one end of the beam 4, said end being welded to a large face of the plate 98. The intermediate beam 52 is not engaged in the closed channel 22, its end being welded to the large face of the plate 48 opposite from the beam 4.

The reinforcing part 92 extends as far as the plate 98. The plate 98 is pierced by an orifice disposed in line with the open channel 20 so as to enable the connection duct 47 to be inserted.

FIG. 6 is a diagram of a machine having rollers 54 for profiling by longitudinal bending, and serving to fold a metal strip 56 in successive stages along longitudinal fold lines in order to obtain the section member 19;

At the inlet to the installation 54, the metal strip 56 is flat and travels lengthwise in direction A. At the outlet from the machine, the strip 56 has been shaped so as to form the section member 19.

Between its inlet and outlet, the machine 54 has a plurality of stations 58, each station 58 having rollers between which the strip 56 is passed, the rollers being of profiles that serve to implement a folding step.

The various steps of folding the strip 56 are described below with reference to FIGS. 7A to 7F, showing the strip 56 in section in a plane perpendicular to its length.

In FIGS. 7A to 7F, the fold lines extend perpendicularly to the planes of FIGS. 7A to 7F, and the locations of the fold lines are indicated by corresponding arrows L1 to L5. The associated folding directions are represented by arrows F1 to F5.

Initially (FIG. 7A), the strip 56 is plane. The strip 56 is then folded by successive steps:
along a line L1 (FIG. 7B), thereby forming an L-shaped section member (FIG. 7C);
along a line L2 (FIG. 7C), thereby forming a crank-shaped profile (FIG. 7D); and
along lines L3 and L4 (FIG. 7D), thereby forming an S-shaped profile (FIG. 7E) having a first loop 60 and a second loop 62, each of which is substantially of channel section, with the loops 60 and 62 sharing a common connection branch 64, and each presenting a free branch, with the 15 free branch 66 of the first loop 60 being longer than the free branch 68 of the second loop 62.

Thereafter, an end of the free branch 66 of the first loop 60 is folded towards the common branch 64 along a line L5 (FIG. 7E). An open section member of section analogous to that of the section member 19 is thus 20 obtained. Thereafter, the section member is closed by using a bead of welding 70 to fasten the end of the branch 66 to the common branch 64 so as to close the first loop 60.

This produces a section member 19 having a 6-shaped section (FIG. 7F). The open channel 20 is defined by the open second loop 62, and the closed channel 22 is defined by the closed first loop 60.

The bead of welding 70 is continuous or made up of discrete spots that are spaced apart along the length of the strip 56.

Thereafter, the section member 19 is cut into segments of appropriate length, each segment forming a beam 4.

Finally, the free longitudinal edges of the section member 19 are subjected to treatment to ensure that they are not sharp. For example, they can be folded towards the inside or the outside of the section member, over a width of a few millimeters.

It should be observed that for the embodiment of FIG. 10, the open face 32 of the channel 20 can be closed locally during the operation of fabricating the beam 4 by bending. Under such circumstances, the open face is closed partially by folding down a flap previously formed on an edge of the strip 56. This flap replaces the fitted-on part 92.

Advantageously, the bead of welding 70 is made continuously by a welding machine 72 disposed downstream from the folding installation 54, prior to cutting up into different beams 4 (FIG. 6).

In a variant, after being cut off, a segment is subjected to further bending so as to give the segment a shape that is longitudinally arcuate.

Openings 50 such as those shown in FIG. 3 are advantageously formed in the beam 4 while it is being fabricated in the installation 54.

For this purpose, a drilling machine 73 is disposed upstream from the installation 54 so that the strip 56 travels flat through the drilling machine 73, with the drilling machine forming openings that are suitably spaced apart along the length of the strip 56 prior to the strip 56 being folded longitudinally.

In a variant, and as shown in dashed lines in FIG. 3, it is possible to form holes 74 in the beam 4 that are spaced apart along the beam 4. The holes 74 serve to reduce the weight of the beam 4. For example, the holes 74 can be formed in the front branch 35 of the section member 19. The closed channel 22 conserves a rigid and generally closed section.

In a variant, holes 74 can be made in the centers of stamped zones 75, as shown in FIGS. 11A and 11B in order to reinforce the beam 4 locally, and also for reasons of accessibility.

These stamped zones 75 are formed in the strip 56 before the holes 74 are made, or at the same time as they are made.

Furthermore, these stamped zones need to present dimensions so as to leave sufficient space along the fold lines to enable the roller machine 54 to be positioned and operated.

The holes 74 are not necessarily in alignment parallel to the line L, and they may be disposed in other ways depending on requirements. These holes serve in particular to position and hold bundles of electric cables, and the positions of the holes 74 can be selected as a function of the paths followed by the bundles.

In a variant shown in FIG. 8, where only the beam 4 is shown, the beam 4 presents varying thickness in a cross-section plane. More precisely, the beam 4 presents a flange 27 and a top segment 36 that are thinner than the remainder of the section of the beam 4.

This serves to lighten the beam 4, by reducing its thickness in its zones that are subjected to lower levels of stress, while maintaining its thickness in the more heavily stressed zones. For example, considerable thickness is necessary in the zones where the force strut 10 is fastened and where the steering column 12 is fastened.

Such a beam 4 is easily formed by welding together metal strips B1, B2, and B3 of different thicknesses along their longitudinal edges by means of beads of welding 77, and then by applying the profiling fabrication method by longitudinal folding as described above to the strip constituted by assembling the strips B1, B2, and B3. In a variant, two strips B1 and B2 can suffice.

The fabrication method makes it easy to fabricate section members of varying and complex sections. FIGS. 9A to 9C show various sections 76, 78, and 80 in the form of closed polygons, respectively a rectangle, an isosceles trapezoid, and an octagon. Each section is formed by longitudinally bending a strip, so as to obtain a section member of open section, and then fastening together the longitudinal edges 82 of the strip by a continuous bead of welding or by spot welds in order to close the section of the section member. In a variant, each section 76, 78, 80 is open, with the longitudinal edges 82 of each section 76, 78, 80 being adjacent or touching but not being fastened to one another.

FIG. 9 shows a section 84 analogous to that of FIG. 1, but that is substantially 8-shaped, thereby defining two juxtaposed channels 86 and 88 that are closed. The section 84 is formed, for example, by longitudinally bending a strip in the manner described with reference to FIGS. 7A to 7F, except that both loops of the S-shape are then closed. In a variant, the longitudinal edges 82 of the section 84 are not welded.

FIG. 9E shows a variant of the FIG. 9D section that also includes a longitudinal element 90 with an L-shaped section that is added to the section 84 so as to create an open channel-section channel 92 extending parallel to the two closed channels 86 and 88.

A longitudinal edge of the element 90 is welded for this purpose along an angle of the section 84, so that a first flange of the element 90 extends longitudinally facing the section 84 and constitutes an outer side of the open channel 92, the second flange of the element 90 constituting the web of the channel 90 and connecting the first flange to the section 84. This produces a beam 4 that is particularly rigid.

The beam shown in the figures presents advantages in terms of stiffness and integration with other equipment of the motor vehicle. In a variant, such a beam is obtained by any appropriate fabrication method, e.g. by extrusion in a die with the necessary holes then being drilled.

In a variant, the beam 4 is obtained by juxtaposing two distinct section members parallel to each other along the line L, and assembling them together along their length.

The beam 4 can be fabricated by methods other than the continuous bending method as described above.

In particular, the beam can be fabricated on a fabrication line constituted by a succession of folding presses 158, and including transfer means 159 for transferring from one press to another (FIG. 12).

In this method, a stack 150 of blanks 156 precut to the length of the beam is placed at the head of the fabrication line. A blank is picked up by the transfer means 159 and is taken to a first folding press to form a first folding operation, e.g. along two first longitudinal fold lines P1 and P2 (FIG. 13A) so as to form a Z-shaped section comprising a central web 160 and two side flanges 161 and 162. The section is then transferred to a second press in order to form a third fold P3 (FIG. 13B) in the flange 161, and then to a third press in order to form two other longitudinal folds P4 and P5 (FIG. 13C) in the flanges 161 and 162, and to a fourth press in order to form folds P6 and P7 in the flanges 161 and 162 (FIG. 13D) which are finally closed to form a section 190 comprising two boxes 163 and 164 defined by the flanges 161 and 162 constituting the outside walls of the boxes and by the web 160 between the two boxes. Thus, the section member is made by a succession of progressive folds. Insofar as the blanks are cut to the dimensions of the beam, there is no need to perform a cutting operation to obtain beams of desired length.

The box sections are stiffened by rigid closure using any appropriate method of the continuous or discontinuous welding type or any type of mechanical connection method such as stapling, folding/crimping, pinching, etc. These connection means can be used regardless of the methods used for shaping. This rigid closure operation can either be integrated in the shaping process, or performed at the end, after the folding operation, away from the folding installation.

1. A motor vehicle dashboard crossmember of the type comprising an elongate beam (4) forming at least one segment of the crossmember, the crossmember being characterized in that the beam (4) is formed from an open section member (19, 76, 78, 80, 84) formed by longitudinally bending a metal strip (56) in order to obtain a member of determined section.

2. A crossmember according to claim 1, characterized in that the section member (19, 84) presents a section defining at least two juxtaposed channels (20, 22) extending parallel to each other along the length of the section member (19, 84).

3. A crossmember according to claim 2, characterized in that the channels (22) present sections that are closed.

4. A crossmember according to claim 2, characterized in that at least one channel (20) presents a section that is open, and at least one channel (22) presents a section that is closed.

5. A crossmember according to claim 4, characterized in that the open channel (20) is defined by a channel-section portion of the section member (19) that has a U-shaped section, and the closed channel is defined by a portion of the section member (19) that has an O-shaped section (22).

6. A crossmember according to claim 4, characterized in that the open channel (20) and the closed channel (22) are defined by at least one wall (27) in common.

7. A crossmember according to claim 1, characterized in that the section member (19) presents varying thickness in a cross-section plane.

8. A crossmember according to claim 1, characterized in that, over another segment of the crossmember, it includes an intermediate beam (52) fastened to said beam (4).

9. An assembly comprising a dashboard crossmember according to claim 4, and at least one air duct (42, 48) of a motor vehicle air conditioning system, the or each air duct (42, 48) extending in the open channel (20) that forms a cavity for receiving the or each air duct (42, 48).

10. A method of fabricating a motor vehicle dashboard crossmember beam (4) in which a section member (19, 190) is formed from a metal strip (56) or blank (156) that is folded along a plurality of longitudinal lines (L1 to L5; P1 to P7).

11. A method according to claim 10, in which the section member (19, 190) is closed at least in part so as to obtain a section defining at least one closed channel (22) by using continuous or discontinuous connection means, e.g. of the stapling, folding/crimping, pinching, or welding types, either during the process of shaping the section member, or subsequently.

12. A method according to claim 10 or claim 11, characterized in that a section member (19) is formed from a metal strip (56) that is moved longitudinally continuously through a roller bending machine (54) so as to bend the metal strip (56) progressively along longitudinal lines (L1 to L5) so as to obtain a section member (19) of determined section, and a segment is taken from the section member (19) in order to form the beam (4).

13. A method according to claim 12, in which the section member (19) is closed by means of a longitudinal weld (40) formed continuously along the section member (19) traveling longitudinally at the outlet from the bending machine (54), prior to cutting off the beam (4).

14. A method according to claim 10, characterized in that the section member (190) is formed from a blank (156) cut to the format of the beam, which blank is allowed to pass through a succession of folding presses (158) so as to fold the blank (156) progressively along fold lines (P1 to P7) in order to obtain a section member (19) of determined section, constituting the beam (4).

15. A method according to claim 10, in which openings (50, 74) distributed along at least one longitudinal line are formed in the strip (56) prior to bending the strip (56) so as to obtain a beam (4) provided with openings distributed along its length.

16. A method according to claim 10, in which the strip (56) or the blank (156) is formed by at least two strips of different thicknesses assembled together along their longitudinal edges, so that the section member (19) presents varying thickness in a section plane.

17. A crossmember according to claim 5, characterized in that the open channel (20) and the closed channel (22) are defined by at least one wall (27) in common.

18. A method according to claim 11, characterized in that a section member (19) is formed from a metal strip (56) that is moved longitudinally continuously through a roller bending machine (54) so as to bend the metal strip (56) progressively along longitudinal lines (L1 to L5) so as to obtain a section member (19) of determined section, and a segment is taken from the section member (19) in order to form the beam (4).

19. A method according to claim 11, characterized in that the section member (190) is formed from a blank (156) cut to the format of the beam, which blank is allowed to pass through a succession of folding presses (158) so as to fold the blank (156) progressively along fold lines (P1 to P7) in order to obtain a section member (19) of determined section, constituting the beam (4).

20. A method according to claim 11, in which openings (50, 74) distributed along at least one longitudinal line are formed in the strip (56) prior to bending the strip (56) so as to obtain a beam (4) provided with openings distributed along its length.
